(19) United States
(12) Patent Application Publication
(10) Pub. No.: US 2007/0103775 A1
(43) Pub. Date: May 10, 2007

(54) PROJECTION DISPLAY DEVICE AND ELECTRONIC APPARATUS WITH THE SAME

(75) Inventors: ZHENG SHI, Shenzhen (CN); JUN ZHANG, Shenzhen (CN); CHIEN-LI TSAI, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/552,972

(22) Filed: Oct. 26, 2006

(30) Foreign Application Priority Data
Nov. 9, 2005 (CN) 200520067275.3

(51) Int. Cl. G09G 5/00; G03B 21/56

(52) U.S. Cl. 359/443; 345/168

(57) ABSTRACT

A projection display device includes a screen for having projected images displayed thereon, a main frame overlaying the top edge and the bottom edge of the screen, a pair of side frames adjustably secured to opposite two sides of the main frame to change transverse distances between the side frames, each of the side frames holding one of the side edges of the screen, and a pair of securing members selectively securing the side frames to the main frame at different positions so as to adjust a viewable size of the screen to present different aspect ratios. An electronic apparatus utilizing the projection display device is also disclosed.

### BACKGROUND OF THE INVENTION

1. Field of the Invention

The present invention generally relates to display devices, and in particular to a projection type display device and an electronic apparatus using the projection display device.

2. Description of Related Art

Various kinds of display devices in existence can be sorted into two types, flat panel type display and non-flat panel type display. A cathode-ray tube (CRT) display is a typical non-flat panel display, and trends indicate it will become obsolete due to its relatively large volume. A liquid crystal display (LCD) is a typical flat panel display.

A liquid crystal display screen is a thin, flat display made up of any number of color or monochrome pixels arrayed in front of a light source or reflector. It is prized by engineers because it uses very small amounts of electric power, and is therefore suitable for use in battery-powered electronic apparatuses. Each pixel consists of a layer of liquid crystal molecules suspended between two transparent electrodes, and two polarizing filters, the axes of polarity of which are perpendicular to each other. The LCD screen is popular due to its compact volume and low power-consumption.

However, the LCD screen is complex in structure, and expensive in cost.

What is needed is a display screen with compact volume and low cost.

### SUMMARY OF THE INVENTION

A projection display device includes a screen for having projected images displayed thereon, a main frame overlaying the top edge and the bottom edge of the screen, a pair of side frames adjustably secured to two opposite sides of the main frame to change transverse distances between the side frames, each of the side frames holding one of the side edges of the screen, and a pair of securing members selectively securing the side frames to the main frame at different positions thereby adjusting a viewable size of the screen to present different aspect ratios.

An electronic apparatus includes a base and a display device pivotably attached to the base. The display device includes an outer casing and a screen received in the outer casing. The screen defines a transverse direction and a longitudinal direction. The outer casing includes a main frame overlaying a back of the screen, and a side frame attaching a side of the screen thereto and reeling in the screen along the transverse direction, the side frame selectively secured to the main frame at at least two different positions along the transverse direction so as to adjust a transverse length of viewable screen to present different aspect ratios.

Other systems, methods, features, and advantages of the present projection display device and the present electronic apparatus will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present projection display device and the present electronic apparatus can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an exploded, isometric view of an outer casing for a display device in accordance with an exemplary embodiment, the outer casing including a main frame and two side frames, and two securing members, and each of the side frame including an engaging member, a reel 40, and a side margin 50;

FIG. 2 is an enlarged view of a circled portion 11 of the main frame in FIG. 1;

FIG. 3 is an enlarged view of the engaging member in FIG. 1;

FIG. 4 is an enlarged view of the securing member in FIG. 4;

FIG. 5 is similar to FIG. 5, but viewed from another aspect;

FIG. 6 is an assembled, isometric view of the outer casing;

FIG. 7 is an enlarged view of a circled portion VII in FIG. 6;

FIG. 8 is an isometric view of a notebook computer in a first aspect ratio according to an exemplary embodiment; and

FIG. 9 is an isometric view of the notebook computer in a second aspect ratio.

### DETAILED DESCRIPTION OF THE INVENTION

Reference will now be made to the drawings to describe the embodiments of the present projection display device and the present electronic apparatus, in detail.

The aspect ratio of an image is a ratio of its display width to its height (usually expressed as “x:y”). For instance, the aspect ratio of a traditional television screen is 4:3, or 1.33:1. High definition television uses an aspect ratio of 16:9, or about 1.78:1. Aspect ratios of 2.39:1 or 1.85:1 are frequently used in cinematography, while the aspect ratio of a sync-sound 35 mm film frame is 1.37:1 (also known as “Academy Aperture” ratio). Silent films, which used the full frame, were shot in 1.33:1.

The 4:3 ratio for standard television has been in use since television's origins and many computer monitors use the same aspect ratio. 4:3 is the aspect ratio defined by the Academy of Motion Picture Arts and Sciences as a standard after the advent of optical sound-on-film. Matching this aspect ratio meant that films previously photographed on film could be satisfactorily viewed on TV in the early days of the medium. When cinema attendance dropped, Hollywood created widescreen aspect ratios to immerse the viewer in a more realistic experience and, possibly, to make the cinema experience more of a spectacle than what could not be achieved at home on a regular TV set. 16:9 is the international standard format of HDTV as used in Australia, Japan, and America, as well as in Europe.

Recently, a move towards widescreen display systems is proceeding. If such systems are realized, a display screen with an aspect ratio of 4:3 will co-exist with an aspect ratio of 16:9.

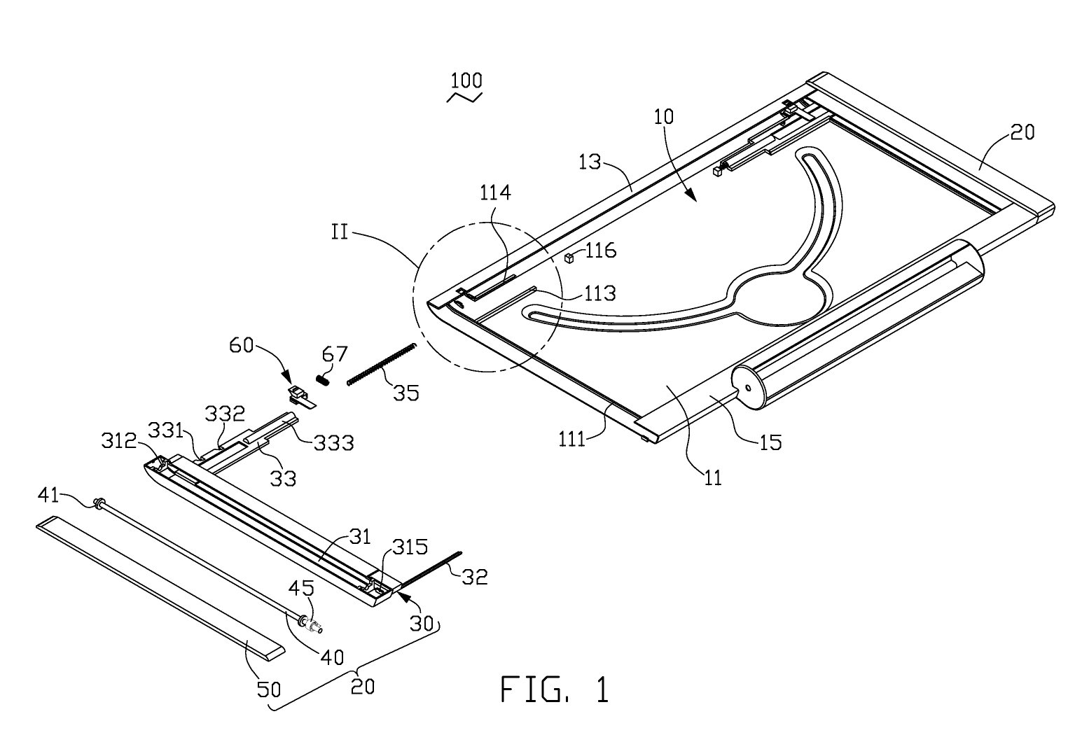

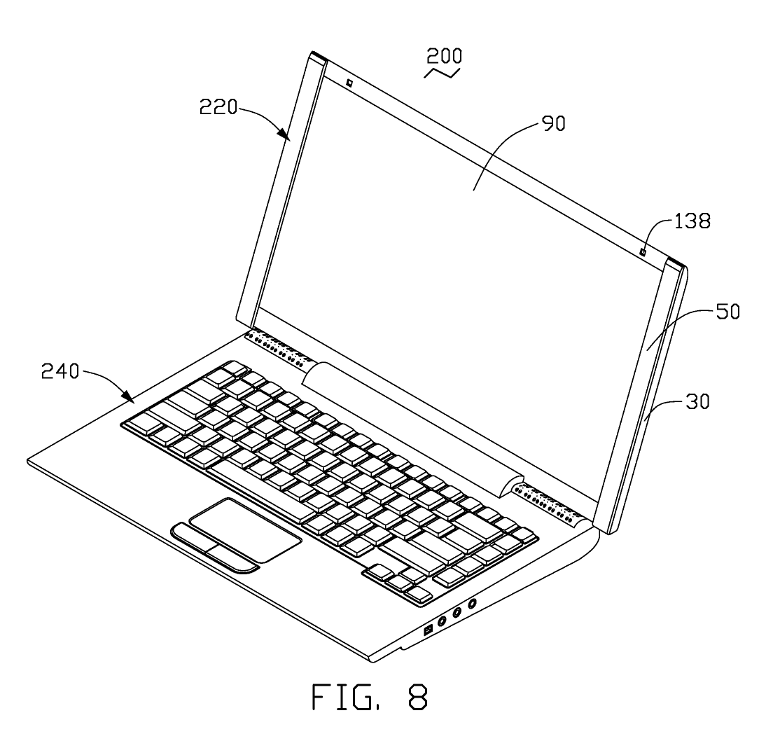

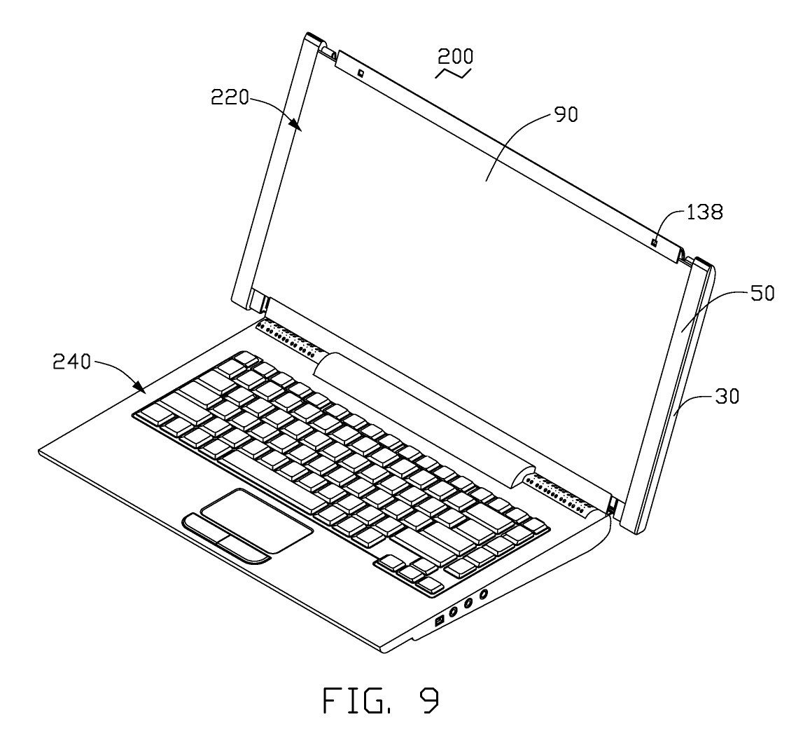

Referring to FIG. 1, an outer casing 100 in accordance with an exemplary embodiment is illustrated. The outer casing 100 is used to mount and secure a flexible screen 90 (as shown in FIG. 8 and FIG. 9) therein, and includes a main frame 10 and two side frames 20. Each of two lateral sides of the screen 90 is attached to the corresponding side frame 20. The side frames 20 are secured to two lateral sides of the main frame 10, and each of the side frames 20 is securable at two different positions with respect to the main frame 10 to define different aspect ratios of a viewable size of the screen 90.

The main frame 10 includes a back plate 11, a top margin 13, and a bottom margin 15. The back plate 11 is a rectangular plate backing the screen 90. The top margin 13 and the bottom margin 15 are respectively bent from a top and a bottom of the back plate 11 to overlay a top edge and a bottom edge of the screen 90.

For ease of description, a transverse direction is defined along the top margin 13 and the bottom margin 15, and a longitudinal direction is defined along a direction perpendicular to the top margin 13 and the bottom margin 15. In addition, as the outer casing 100 is symmetrical with respect to an axis along the longitudinal direction thereof, hereunder only a left half of the outer casing 100 is described.

The back plate 11 includes a stopping rib 111, a first guiding rib 113, a second guiding rib (not shown), a third guiding rib 114, and a resisting block 116. The stopping rib 111 is formed along the longitudinal direction of the outer casing 100, and the first guiding rib 113, the second guiding rib, and the third guiding rib 114 are formed along the transverse direction. The second guiding rib is located in a vicinity of the bottom margin 15.

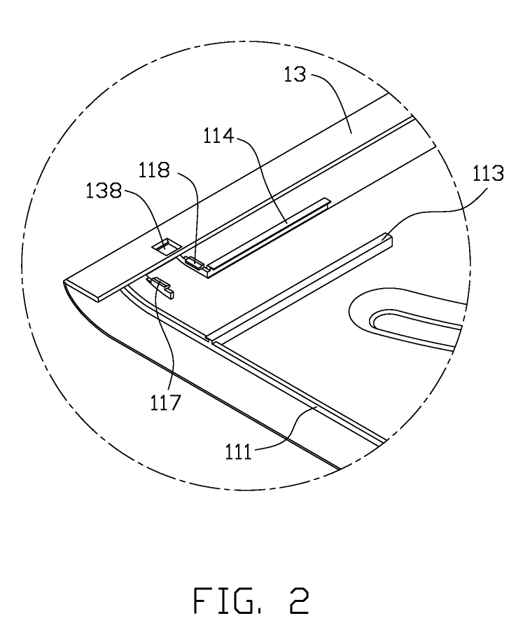

Referring to FIG. 2, a detailed structure of a corner of the outer casing 100 is illustrated. A pair of mounting pieces 117, 118 is formed under the top margin 13, and an opening 138 is defined in the top margin 13 between the mounting pieces 117, 118. The mounting piece 118 is located in a vicinity of the third guiding rib 114, and the mounting piece 117 is spaced away from the mounting piece 118. Referring back to FIG. 1, a securing member 60 can be slideably received between the mounting pieces 117, 118, with a first compression spring 67 sandwiched between the securing member 60 and the back plate 11 to provide a first restoration force along the longitudinal direction of the outer casing 100 when the securing member 60 is moved towards the top margin 13.

The side frame 20 includes an engaging member 30, a reel 40, and a side margin 50. The reel 40 is mounted in the engaging member 30, and sealed by the side margin 50. The engaging member 30 is securable to the main frame 10 at two different positions to mount the screen 90 to the main frame 10 to define different viewable aspect ratios of the screen 90.

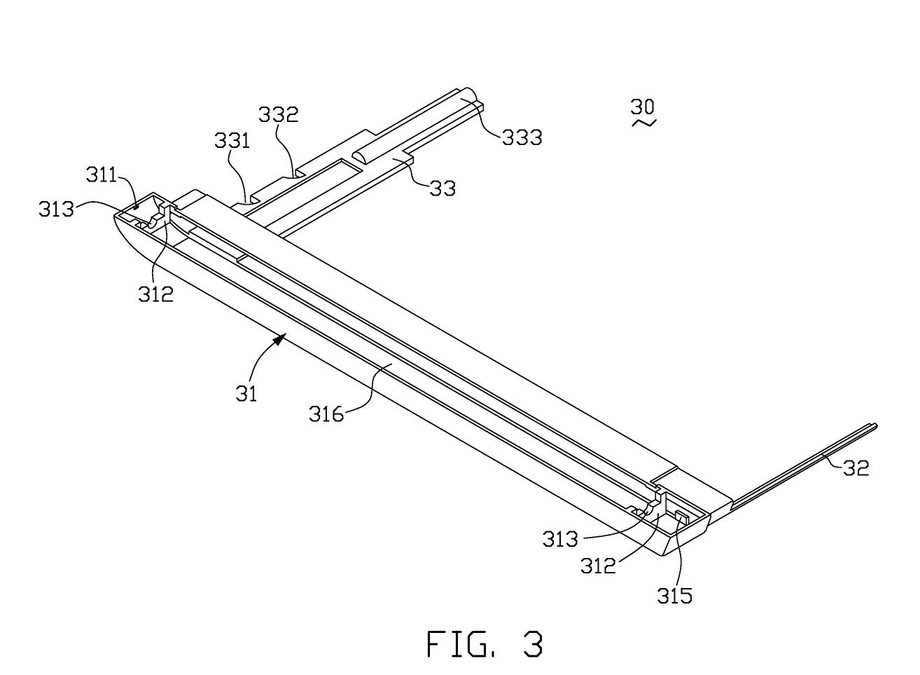

Referring also to FIG. 3, the engaging member 30 includes a main portion 31, a guiding portion 32, and an adjusting portion 33. The guiding portion 32 and the adjusting portion 33 respectively extend perpendicularly from two ends of the main portion 31 to the main frame 10. The main portion 31 is blockable by the stopping rib 111 to stop it moving across the stopping rib 111 once the side frame 20 is mounted to the main frame 10. The main portion 31 defines a recess 316 to receive the reel 40 therein. The main portion 31 includes a pair of supporting plates 312, and a locking piece 315. The supporting plates 312 each with a notch 313 therein are formed next to each end of the main portion 31 respectively. The supporting plates 312 are used to support the reel 40, and the notches 213 are used to accommodate the reel 40 therein. The locking piece 315 is formed next to one of the supporting plates 213. A clasping hole 311 is defined in one distal end of the main portion 31 to engage with hooks (not shown) formed on the side margin 50 to mount the side margin 50 to the engaging member 30 and enclose the reel 40 in the recess 314 of the engaging member 30. A cross section of the guiding portion 32 is in a reverse L shape, and can be coupled to the second guiding rib with a cross section in an L shape. The adjusting portion 33 is guided between the first guiding rib 113 and the third guiding rib 114 of the main frame 10, and defines a first gap 331 and a second gap 332 along the transverse direction. The securing member 60 is selectively engageable in the first gap 331 or the second gap 332. A housing 333 is formed at a distal end of the adjusting portion 33. The housing 333 defines therein a void being used to receive a second compression spring 35 therein.

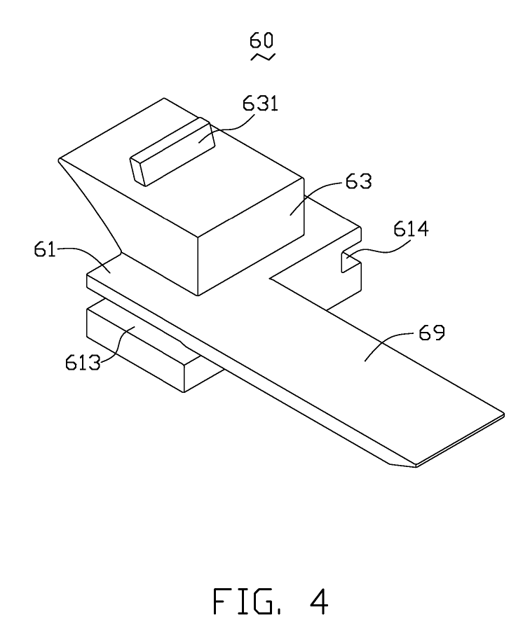

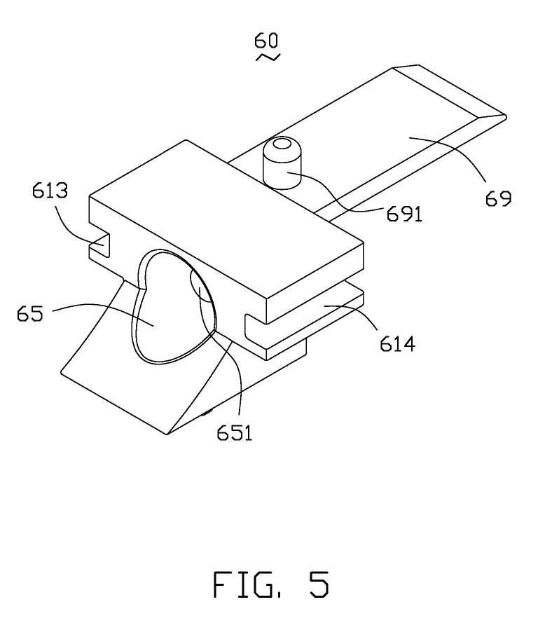

Referring to FIG. 4 and FIG. 5, the securing member 60 includes a main block 61, a projecting block 63, and a limiting arm 69. The projecting block 63 is formed on the main block 61, and the limiting arm 69 extends from a side of the main block 61 towards the longitudinal direction of the outer casing 100. A pair of mounting grooves 613, 614 is defined at two lateral sides of the main block 61 respectively, to be engaged by the mounting pieces 117, 118 of the main frame 10, to guide the securing member 60 to move along the longitudinal direction of the outer casing 100. An operating piece 631 is formed on the projecting block 63 to extend through the opening 138, in order to be reachable and moveable by a user. A mounting rod 651 extends through a hole 65 defined in the main block 61 and the projecting block 63, along the longitudinal direction. The limiting arm 69 extends along the longitudinal direction to limit the adjusting portion 33 of the engaging member 30 between the limiting arm 69 and the back plate 11. A wedging rod 691 extends backward from the limiting arm 69. The wedging rod 691 can be selectively engaged in the first gap 331 or the second gap 332 to define the different viewable aspect ratios of the screen 90.

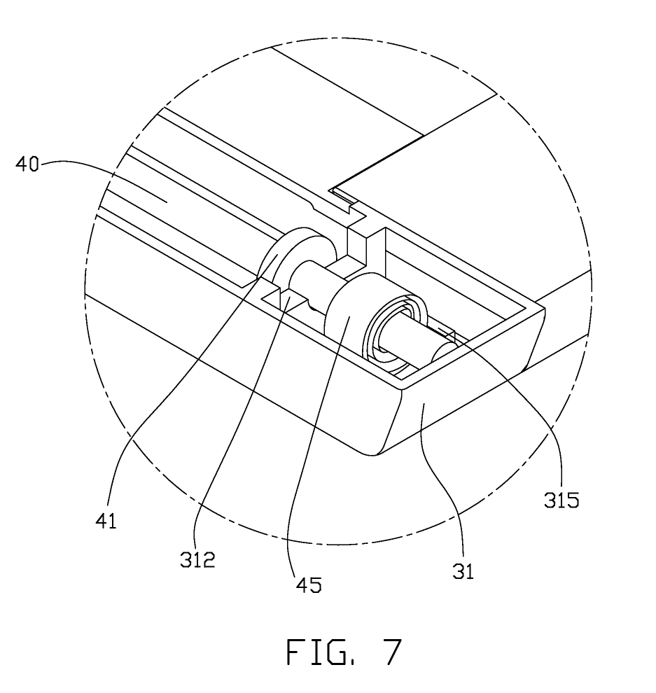

Referring to FIG. 7, the reel 40 includes a pair of positioning rings 41, and a rollback mechanism 45. The positioning rings 41 are sleeved on the reel 40, and are respectively positioned next to the supporting plates 312 to stop the reel 40 moving along an axial direction of the reel 40, i.e. the longitudinal direction of the outer casing 100. The rollback mechanism 45 provides a rolling force that makes the reel 40 draw back the screen 90 once the reel 40 is rotated by an external force. The rollback mechanism 45 can be a mainspring for example. One end of the rollback mechanism 45 is attached to the reel 40, and the other end of the rollback mechanism 45 is locked in place by the locking piece 315.

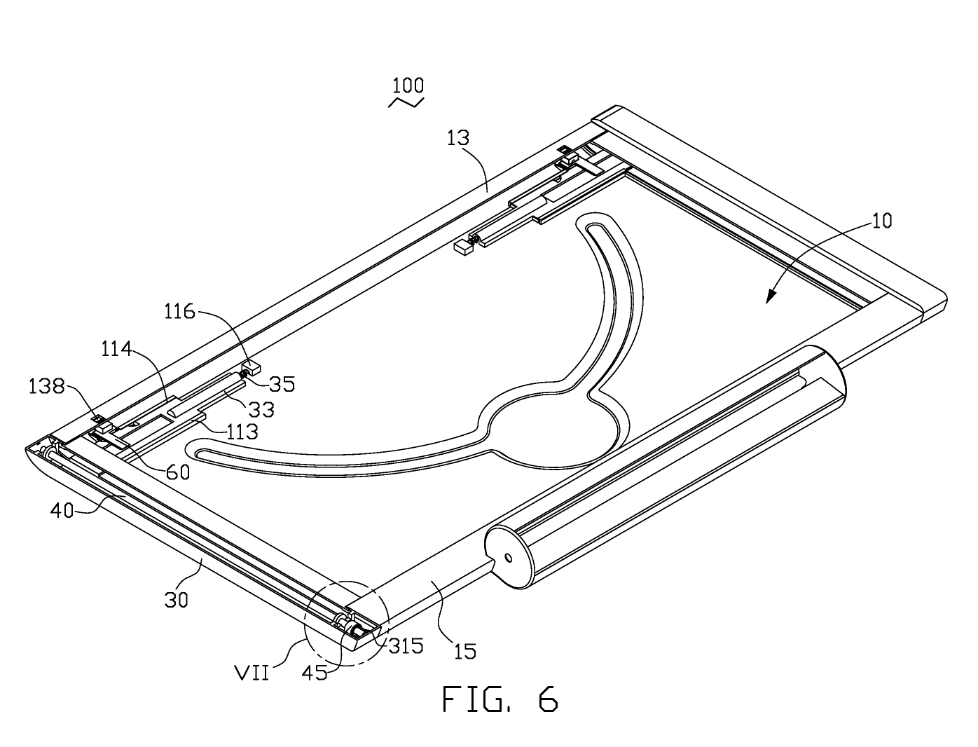

Referring to FIG. 6, an assembled structure of the outer casing 100 will be described in detail. The side frames 20 are attached to two opposite ends of the main frame 10. The adjusting portion 33 of each side frame 20 is slideably engaged between the first guiding rib 113 and the third guiding rib 114 of the main frame 10 and the guiding portion 32 is slideably engaged with the second guiding rib. The second compression spring 35 is received in the housing 333 of the adjusting portion 33 and one end thereof abuts against the resisting block 116 to provide a second restoration force along the transverse direction. The securing member 60 is mounted between the mounting pieces 117 and 118 of the main frame 10. The limiting arm 69 abuts on the adjusting portion 33 of the engaging member 30 to limit the adjusting portion 33 between the limiting arm 69 and the back plate 11. The first compression spring 67 is received in the hole 65 of the securing member 60 with one end thereof being sleeved on the mounting rod 651 and the other end abutting against the joint between the top margin 13 and the back plate 11 of the main frame 10. The operating piece 631 of the securing member 60 is received in the opening 138 in the top margin 13. The wedging rod 691 of the securing member 60 is disengageable from the first gap 331 or the second gap 332 under an external force and engages into the first gap 331 or the second gap 332 under the first restoration force of the first compression spring 67. Once the side frame 20 is released by the securing member 60, the side frame 20 is forced to move in the transverse direction under the second restoration force of the second compression spring 35 until reaching and being blocked by the stopping rib 111.

Referring to FIG. 8 and FIG. 9, the outer casing 100 is utilized in an electronic apparatus, for example a notebook computer 200, as a projection display device thereof. The notebook computer 200 includes a base 240 and a display device 220 pivotably attached to the base 240. The base 240 accommodates a projector (not shown) therein for projecting images to be displayed on the screen 90. The notebook computer 200 is able to shift between a first aspect ratio and a second aspect ratio, wherein the second aspect ratio is larger than the first aspect ratio. The notebook computer 200 with the first aspect ratio is illustrated in FIG. 8, and the notebook computer 200 with the second aspect ratio is illustrated in FIG. 9.

In the first aspect ratio, the wedging rods 691 of the securing members 60 are wedged in the corresponding first gaps 331 of the engaging members 30, under the first restoration forces of the first compression springs 67.

When shifting from the first aspect ratio to the second aspect ratio, the operating pieces 631 of the securing members 60 in the openings 138 are triggered by manipulation of a user in a direction along the mounting pieces 117 and 118, and the first compression springs 67 are compressed. The wedging rods 691 of the securing members 60 gradually move out from the first gaps 331 in the engaging members 30. As the wedging rods 691 completely leave the first gaps 331, the side frame 20 is forced to move outward along the first guiding rib 113 and the third guiding rib 114 with the aid of the second restoration forces of the second compression springs 35, and the reels 40 rotate in the notches 313 against the rolling-up force of the rollback mechanisms 45 thus unrolling portions of the screen 90 to locate at opposite sides of the main frame 10, that is, the unrolled portions of the screen 90 are revealed. When the engaging member 30 of the side frame 20 is moved to be blocked by the stopping rib 111 and the second gaps 332 in the side frame 20 align with the respective wedging rods 691 of the corresponding securing members 60, the operating pieces 631 of the securing members 60 are released and the wedging rods 691 of the securing members 60 wedge into the corresponding second gaps 332 under the first restoration forces of the first compression springs 67. The side frames 20 stop moving, and are fixed by the securing members 60. The rollback mechanisms 45 apply tension forces to the reels 40, keeping surfaces of the screen 90 smooth once positioned in place.

After the above procedure, the aspect ratio of the display device of the notebook computer 200 is the second aspect ratio as shown in FIG. 9.

When shifting from the second aspect ratio to the first aspect ratio, the operating pieces 631 are triggered once again, and the first compression springs 67 are compressed. The wedging rods 691 of the securing members 60 gradually move out from the second gaps 331 in the engaging members 30. As the wedging rods 691 completely leave the second gaps 331, the side frame 20 is forced to move inward along the first guiding rib 113 and the third guiding rib 114, and the reels 40 rotate in the notches 313 thus rolling up the portions of the screen 90 located at opposite sides of the main frame 10 under the aid of the rollback mechanisms 45, that is, the portions of the screen 90 located at opposite sides of the main frame 10 are concealed. When the engaging member 30 of the side frame 20 is moved to be blocked by edge of the main frame 10 and the first gaps 332 in the side frame 20 aligns with the respective wedging rods 691 of the corresponding securing members 60, the securing members 60 are released and the wedging rods 691 of the securing members 60 wedge into the corresponding first gaps 332 under the first restoration forces of the first compression springs 67. The side frames 20 stop moving, and are fixed by the securing members 60. The rollback mechanisms 45 apply tension forces to the reels 40, keeping viewing surfaces of the screen 90 smooth once in position.

After the above procedure, the aspect ratio of the display device of the notebook computer 200 is the first aspect ratio as shown in FIG. 8.

As described above, the outer casing 100 can change transverse length thereof to change the aspect ratio of the viewable surface of the screen 90. Users can choose any desired aspect ratio. When needed, the adjusting portion 33 can define gaps in different positions thereof to change the length of the outer casing 100 along the transverse direction to present different sizes of viewable surfaces of the screen 90 thereby presenting different aspect ratios.

The above outer casing 100 and the display device of the notebook computer 200 are symmetrical with respect to the axis along the longitudinal direction, and both of the side frames 20 are movable along the transverse direction to change the aspect ratio. An asymmetrical structure is an alternative modification of the above embodiment to carry out aspect ratio switch.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A projection display device, comprising:
a flexible screen for having projected images displayed thereon, the screen including a top edge, a bottom edge, and a pair of side edges;
a main frame overlaying the top edge and the bottom edge of the screen;
a pair of side frames adjustably secured to two opposite sides of the main frame to change transverse distances between the side frames, each of the side frames holding one of the side edges of the screen; and
a pair of securing members selectively securing the side frames to the main frame at different positions thereby adjusting a viewable size of the screen to present different aspect ratios.

2. The projection display device as claimed in claim 1, wherein each of the side frames includes a reel for rolling up the screen thereon and a rollback mechanism sleeved on the reel for providing a rolling force to the reel for rolling up the corresponding reel together with portion of the screen attached to the corresponding reel.

3. The projection display device as claimed in claim 1, wherein each of the side frames includes an engaging member, the engaging member defines a first gap and a second gap, and the securing members selectively engage in the first gaps and the second gaps.

4. The projection display device as claimed in claim 3, wherein a first compression spring is positioned between each of the securing members and the main frame to provide a first restoration force along a longitudinal direction of the main frame to the corresponding securing member, aiding the corresponding securing member to engage into the corresponding first gap or the corresponding second gap.

5. The projection display device as claimed in claim 1, wherein a compression spring is positioned between each of the side frames and the main frame to provide a second restoration force along a transverse direction of the main frame to the corresponding side frame, aiding the corresponding side frame to move along the transverse direction.

6. The projection display device as claimed in claim 1, wherein the main frame forms a pair of mounting pieces along a longitudinal direction to limit one of the securing members therebetween and guide the one of the securing members to move along the longitudinal direction.

7. The projection display device as claimed in claim 6, wherein each of the securing member forms an operating piece for having a force applied thereon, and the main frame defines an opening therein to allow the operating piece to extend therethrough.

8. An electronic apparatus, comprising:
a base; and
a display device pivotably attached to the base, the display device including an outer casing and a screen received in the outer casing, the screen defining a transverse direction and a longitudinal direction, the outer casing comprising:
a main frame overlaying a back of the screen; and
a side frame attaching a lateral side of the screen thereto and being capable of drawing out the screen along the transverse direction, the side frame being capable of selectively secured to the main frame at at least two different positions along the transverse direction so as to adjust a transverse viewable length of the screen to present different aspect ratios.

9. The electronic apparatus as claimed in claim 8, further comprising a securing member, the securing member selectively securing the side frame to the main frame at the at least two different positions along the transverse direction.

10. The electronic apparatus as claimed in claim 9, wherein the securing member is movable along the longitudinal direction to release the side frame, and is restored under a first restoration force applied by a first compression spring positioned between the securing member and the main frame.

11. The electronic apparatus as claimed in claim 8, further comprising a spring for providing a restoration force along the transverse direction to the side frame.

12. The electronic apparatus as claimed in claim 8, wherein the side frame comprises a reel and a rollback mechanism sleeved on the reel, and the rollback mechanism provides a rolling force to the reel to draw back the screen along the transverse direction.

13. The electronic apparatus as claimed in claim 12, wherein the rollback mechanism is a mainspring.

14. The electronic apparatus as claimed in claim 8, wherein the side frame defines a plurality of gaps along the transverse direction, and the securing member selectively engages in the plurality of gaps to change an aspect ratio of the screen.

15. The electronic apparatus as claimed in claim 8, wherein the main frame defines an opening therein to allow an operating piece of the securing member to extend therethrough and be reachable by a user.

16. An electronic apparatus, comprising:
a base having a projector for projecting images; and
a display device pivotably attached to the base, the display device including an outer casing and a screen configured for displaying the projected images thereon and secured in the outer casing, the screen defining a transverse direction and a longitudinal direction, the outer casing comprising:
a main frame overlaying a back of the screen;
a side frame with a side of the screen attached thereto mounted to one side of the main frame, the side frame being capable of sliding with respect to the main frame between at least two different positions along the transverse direction to retract or extend one portion of the screen; and
a securing member structured and arranged for selectively positioning the side frame to the main frame at any one of the at least two different positions thereby adjusting a viewable transverse size of the screen to present different aspect ratios.

17. The electronic apparatus as claimed in claim 16, wherein the side frame comprises an engaging member slideably mounted to the main frame, a reel configured for rolling the screen thereon and mounted in the engaging member, and a rollback mechanism connected between the reel and the engaging member and configured for providing a rolling force to the reel to allow the reel to retract the portion of the screen when the side frame moves toward the main frame.

18. The electronic apparatus as claimed in claim 17, wherein the engaging member comprises at least two cutouts arranged in the transverse direction, and the securing member comprises a locking portion being selectively engageable in any one of the at least two cutouts to thereby position the side frame to the main frame.

19. The electronic apparatus as claimed in claim 18, wherein the securing member is movable with respect to the main frame along the longitudinal direction to release the side frame, and is restored under a restoration force applied by an elastic member positioned between the securing member and the main frame.

20. The electronic apparatus as claimed in claim 16, wherein the main frame comprises a stopping rib extending along the longitudinal direction for limiting the side frame sliding outward.
